(19) United States
(12) Patent Application Publication
(10) Pub. No.: US 2004/0015301 A1
(43) Pub. Date: Jan. 22, 2004

(54) Method for protein functional assignment

(76) Inventors: Mariusz Milik, San Diego, CA (US); Sandor Szalma, San Diego, CA (US); Krzysztof Olszewski, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/417,891

(22) Filed: Apr. 15, 2003

Related U.S. Application Data
(60) Provisional application No. 60/373,597, filed on Apr. 17, 2002.

(51) Int. Cl. G06F 19/00

(52) U.S. Cl. 702/27

(57) ABSTRACT

The present disclosure includes a method for locating functionally relevant atoms in protein structures, and a representation of spatial arrangements of these atoms allowing for flexible description of active sites in proteins. The search method can be based on comparison of local structure features of proteins that share a common biochemical function. Generally, the method does not depend on overall similarity of structures and sequences of compared proteins, or on previous knowledge about functionally relevant residues. The compared protein structures can be condensed to a graph representation, with atoms as nodes and distances as edge labels. Protein graphs can then be compared to extract all possible Common Structural Cliques. These cliques can be merged to create structural templates: graphs that describe structural analogies between compared proteins. Structures of serine endopeptidases were compared in pairs using the presented algorithm with different geometrical parameters. Additionally, a structural template was extracted from the structures of aminotransferases, two different proteins that catalyze the same type of chemical reaction. Presented results show that the method works efficiently even in the case of large protein systems, and allows for extraction of common structural features from proteins catalyzing a particular chemical reaction, but that evolved from different ancestors by convergent evolution.

### RELATED APPLICATIONS

This application claims priority from U.S. Provisional Application No. 60/373,597 entitled METHOD FOR PROTEIN FUNCTIONAL ASSIGNMENT filed on Apr. 17, 2002. The subject matter of the aforementioned application is hereby incorporated by reference in its entirety.

### SUMMARY OF THE INVENTION

1. Field of the Invention

The present invention relates to predicting the activity of macromolecules, such as proteins, based on comparing their molecular structure to that of other macromolecules.

2. Description of the Related Art

Proteins belonging to the same functional family often share common local structural features even if there is no evolutionary dependence or sequence similarity between them. In many cases, and particularly in the case of enzymes, protein function is often determined by the chemical character and spatial arrangement of a few selected atoms. These atoms may form the actual active site of the protein, bind a particular substrate, or coordinate a prosthetic group or a metal ion that catalyzes the specific chemical reaction.

Looking at protein structures from the functional perspective, one may distinguish two classes of protein residues: (i) functionally relevant residues that participate in the specific protein function, and (ii) scaffold residues that form the structural environment for the functional residues, keeping them in proper spatial configuration. Obviously, such a division is in many cases arbitrary and artificial. It may be used, however, as a starting point for a more advanced analysis of structure-function relationships in proteins. This focuses interest on a small subset of residues that are extracted from the whole protein structure, and that are expected to contain most of the function-related information for the given protein. Additionally, knowledge of the most functionally relevant residues can enhance functional annotation of low homology sequence alignments (e.g. Reddy et al. 2001) because it is expected that the functionally relevant residues would be better conserved in the evolutionary process than the structural ones (Lesk and Chothia 1980; Chothia and Lesk 1986). For example, it is possible to drastically mutate structural scaffold residues of proteins without significant disruption of their functionality (Gassner et al., 1996; Axe et al. 1996; Chotia and Gerstein 1997). Moreover, atoms from the functional residues are expected to form similar arrangements both in homologous and in evolutionarily unrelated proteins performing the same biological function (for example, the aminotransferases family discussed in Petsko and Ringe 2002). Therefore, functional annotation procedures based on functionally relevant residues can be applied to non-homologous proteins expected to perform similar biological functions (Russell 1998; Russell et al. 1998).

Comparison of protein structures and searches for structural templates of functionally relevant residues currently concern many research groups. A sub-graph isomorphism algorithm was proposed by Artymiuk et al. for searching protein structures for user-defined 3D patterns (Artymiuk et al. 1994). Patterns were defined based on the prior knowledge of functional residues in the given protein family. Those authors used a reduced side chain representation of protein structures. Pattern geometry was represented by a graph with the side chains as nodes and interatomic distances as edges. In another approach, Fisher et al. used geometric hashing for a α-only representation of protein structure (Fisher et al. 1994, 1995). Because protein structures were represented there as unconnected spheres centered at Cα coordinates, the extracted patterns were sequence-independent. The patterns resulted from automated clustering of pairs of compatible spheres. Wallace et al. proposed a similar method applying the geometric hashing paradigm to protein structures in expanded side chain representation (Wallace et al. 1996, 1997). The patterns, containing a set of atoms defining the active site and a list of allowed amino acids, were stored in the PROCAT database. In another approach, Russel proposed a 3D pattern extraction method based on comparison of conserved residues from protein structures (Russel 1998), using multiple sequence alignment to define patterns. Each residue was represented by three atoms, and a weighted root-mean-square deviation (RMSD) between residues was used as a similarity measure. Another method, proposed by Fetrow et al. and Di Gennaro et al., used a Cα only representation of protein structures, distance conservation for each pair of residues, and additional sequence-depending constraints, to define Fuzzy Functional Forms (FFF's) (Fetrow et al. 1998; Di Gennaro et al., 2001). The FFF's definition of structural pattern is rooted strongly in expert knowledge and literature analysis. Turcotte et al. proposed a machine learning method for protein fold recognition (Turcotte et al. 2001). Using the derived rules, they were able to assign automatically protein structures to the proper SCOP families. Unfortunately, common protein folds do not always imply a common biological function. Irving at al. designed a method for protein active sites identification by structural alignments (Irving at al. 2001). The method was used to suggest the locations of plausible active sites in homologous proteins, and it was based on a search of maximal common sub-cluster of Cα atoms. Another method combined sequence threading with chemostructural restrictions to detect functionally important, and evolutionarily conserved, fragments of protein structures (Reva et al. 2002). The restrictions applied during the threading procedure are extracted from experimental data and from literature analysis. The method was applied to refine a homology model of dipeptidylpeptidase IV.

Most of these structure comparison methods, based on rigid structure comparison (measured by RMS distance between atoms), use very restricted (for example. Cα-only), representations, or require external knowledge about residues belonging to the eventual functionally relevant site. The rigid structure comparison methods work best for reasonably similar protein domains that share a common fold. It may be difficult to compare, using these methods, active sites of two proteins with low sequence similarity or of converged proteins, without additional information about possible active site definition. Additionally, in the case of evolutionarily close proteins, and in the case of Cα-only representations, it is difficult to distinguish between residues conserved because of their functional importance and structural scaffold role.

Hence, there exists a need for an automated pattern detection approach. Preferably, such an approach would not require prior knowledge about active sites.

### SUMMARY OF THE INVENTION

One aspect of the invention is a method of analyzing a selected molecule under study including the steps of: extracting a set of feature cliques which are common to both a first molecule and a second molecule such that each feature clique extracted from the first molecule maps to at least one corresponding extracted feature clique with similar characteristics in the second molecule; identifying a set of at least two feature cliques in the first molecule which overlap, wherein the feature cliques of the second molecule which correspond to the at least two overlapping feature cliques of the first molecule also exhibit a corresponding overlap; and defining a structural template including the set of features of the first molecule included in the overlapping cliques; comparing the structural template to feature positions in the selected molecule under study.

Another aspect of the invention is a method of defining a structural template indicative of molecular function including the steps of: defining a set of N features; and defining a set of relative distances between the N features, wherein the set defines at least one relative distance between each one of the N features to at least one other of the N features, and wherein the set defines less than the N(N−1)/2 possible relative distances between all of the N features.

Another aspect of the invention is a method of identifying a functionally significant atom group comprising a portion of a larger molecule, the method including the steps of: identifying a plurality of relatively small atom groups which appear in both a first molecule and a second molecule; and identifying at least one larger atom group formed by a plurality of overlapping ones of the small atom groups, the larger atom group being defined by identifying a corresponding overlap of corresponding small atom groups in both of the molecules.

Another aspect of the invention is a method of locating a functionally significant molecular portion including the steps of: extracting a set of feature cliques which are common to both a first molecule and a second molecule such that each feature clique identified in the first molecule maps to at least one corresponding feature clique in the second molecule having similar characteristics; identifying a set of at least two feature cliques in the first molecule which overlap, wherein the feature cliques of the second molecule which correspond to the overlapping feature cliques of the first molecule also exhibit a corresponding overlap; defining a structural template including the set of features of the first molecule included in the overlapping cliques; and identifying the location on the molecule where the features of the structural template are located.

Another aspect of the invention is a method of defining a functionally significant structural molecular feature including the steps of: defining a set of features, each feature having one or more selected physical characteristics; and defining a set of distances between some of the features but not all of the features.

Another aspect of the invention is a method of defining a structural template of molecular features including the steps of: defining a set of features and a set of conserved distances between the features, wherein the features are defined by: extracting a set of feature cliques which are common to both a first molecule and a second molecule such that each feature clique identified in the first molecule maps to at least one corresponding feature clique in the second molecule having similar characteristics; identifying a set of at least two feature cliques in the first molecule which overlap, wherein the feature cliques of the second molecule which correspond to the overlapping feature cliques of the first molecule also exhibit a corresponding overlap; and defining the features of the structural template as the set of features of the first molecule included in the overlapping cliques; and wherein the set of conserved distances is defined to include only those distances between a selected pair of features when both features of the selected pair are members of a common feature clique.

Another aspect of the invention is a computer readable media having stored thereon computer code operative to perform one of these methods.

### BRIEF DESCRIPTION OF THE DRAWINGS

FIGS. 1A and 1B are conceptual illustrations of two molecules having areas of common atom configuration

FIGS. 2A and 2B are conceptual illustrations of common atom groups (cliques) in the molecules of FIGS. 1A and 1B.

FIGS. 3A-3D conceptually illustrate several atomic configurations forming overlapping cliques

FIG. 4 illustrates overlapping common atom cliques in two example protein molecules.

FIG. 5 shows an example of a conflict in a structural template draft.

FIG. 6 shows the effect of distance threshold on the number of local atom cliques extracted from a protein structure.

FIG. 7 shows an example of spatial arrangement of atoms in a structural template.

FIG. 8 shows a spatial arrangement of atoms in two different structures included in a structural template definition.

### DETAILED DESCRIPTION

Some embodiments of the present invention include a method of identifying atom configurations called “cliques.” As used herein, “clique” refers to a group of atoms in a molecule such that the atoms are spatially oriented within a defined distance threshold to one another. Atoms in a clique are not necessarily bound to one another, but generally have a spatial configuration that is somewhat rigid and is based on the geometry of the molecule. In some useful embodiments, for example, cliques contain four atoms and are defined by a distance threshold of 8 Å. It should be recognized that although a particular defined region of space can contain several atoms, it may be possible to extract many cliques from that region of space by including or excluding various atoms. For example, if the distance threshold is set at 8 Å and five atoms of interest in a molecule are all located within 8 Å of each other, there would be one five-atom clique and five different four-atom cliques, using just those five atoms. In some embodiments, it is not advantageous to consider every single atom in a molecule when developing possible cliques. In considering the use of structure to predict function in proteins, for example, polar side chain atoms such as oxygen are most significant because they are more likely to play a prominent role in protein function. Further, it can be advantageous to classify atoms not only by their chemical element, but also by their electronic state. In this way, an oxygen atom in an alcohol group can be classified differently than an oxygen atom in an acid group.

When similar atom cliques appear in two different molecules, the molecules are said to contain Common Structural Cliques (CSCs). CSCs should generally contain atoms of the same classifications and have similar distances between those atoms. Whether two cliques in different molecules are “CSCs” is generally based on a user-defined tolerance for discrepancy in the inter-atom distances. In some useful embodiments, for example, tolerance is 1 Å, which is to say that assuming the atoms are of corresponding classifications, the corresponding distances between atoms of the same clique should not vary by more than 1 Å. This fuzziness in distance metric can be applied to take into account both natural flexibility of protein structures and experimental errors in establishing protein atom coordinates. As discussed herein, investigating CSCs that appear in different molecules can facilitate an understanding of the activity and function of those molecules.

In some embodiments of the present invention, CSCs can be used to automatically locate functionally relevant atoms in protein structures. In some embodiments, the method provides a representation of spatial arrangements of the functional atoms and allows for the flexible description of active/binding sites in proteins. Particularly useful representations of this type can allow formal description of flexible structural patterns that contain multiple rigid sub-patterns connected by flexible hinges. In some embodiments, the search method is based on the comparison of protein structures that share a common biological function. Advantageously, the method does not depend on overall similarity of structures and sequences of compared proteins, or on previous knowledge about functionally relevant residues in the considered protein family.

In some embodiments of the present invention, new algorithms can be applied to the extraction of functionally significant similarities between protein structures. In some preferred embodiments, attention is directed particularly to multi-atom cliques in comparing two protein structures. The use of four-atom cliques has been found useful for performing a search for significant pattern matches in both structures. Heuristic algorithms can also be used, but are generally less useful for performing an exhaustive search. Some embodiments of the present invention include the use of algorithms that automatically search for a functionally significant structural template by finding overlapping multi-atom cliques containing atom pairs having the maximal number of overlaps (algorithms are described in further detail below). Alternatively, a manual procedure can be used to establish a structural template.

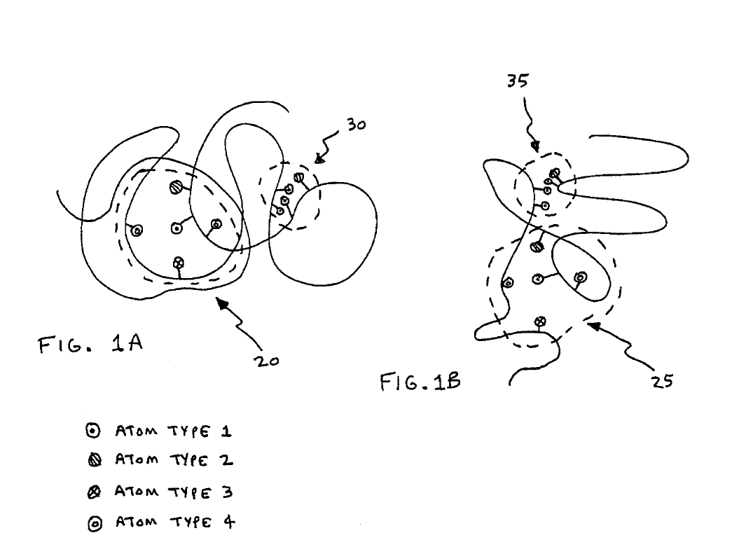

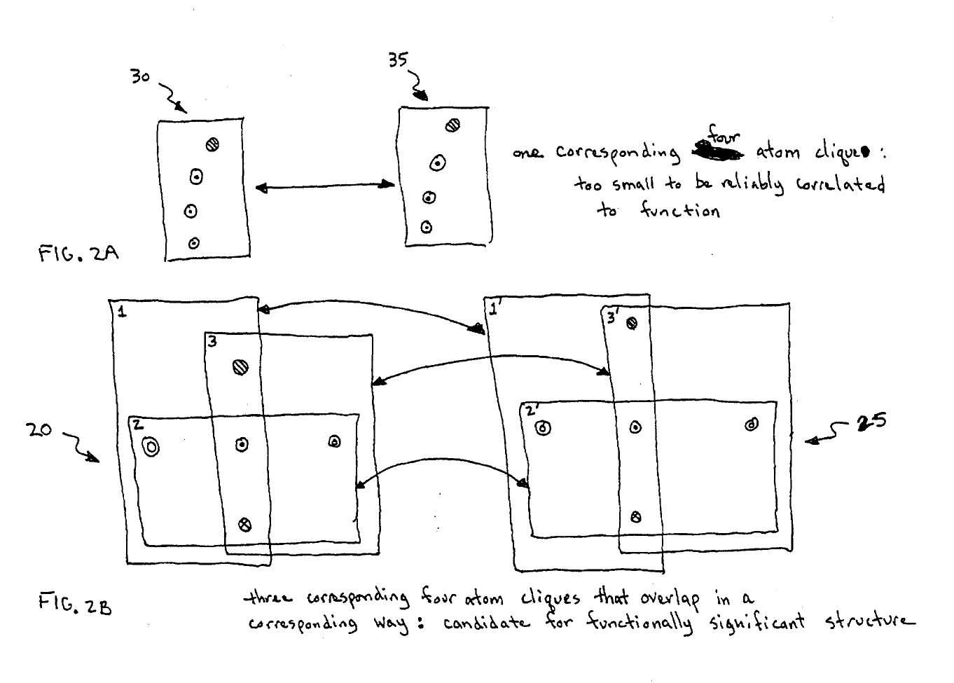

Fundamental aspects of the principle are illustrated in FIGS. 1A, 1B and 2A and 2B. FIGS. 1A and 1B represent two different protein structures with the folded amino acid chain represented as a curving solid line. If these two proteins exhibit a common enzymatic activity, for example, it can be expected that regardless of fold similarity, sequence similarity, or evolutionary relationship, both proteins will form, somewhere in their three dimensional structures, a spatially similar arrangement of a few atoms of the same chemical nature that actually are involved in the protein function. In FIGS. 1A and 1B, the functionally significant atomic arrangement common to both proteins and forming the active site is a five atom arrangement of four different atom types designated 20 in FIGS. 1A and 25 in FIG. 1B. If it is known that the two proteins share a common function, and it is desired to discover which atoms are functionally significant, the problem can be stated in a conceptual way rather simply as follows: find the important region of common atomic configuration between the two proteins, and this is likely to be the active site.

This problem can be approached by representing protein structures as undirected, shaded graphs. In such a representation, vertices of the graph are formed by protein atoms, and are characterized (and shaded) according to atom properties (e.g., type of atom, atom PDB name, residue type, etc.). Edges of the graph can be labeled with Euclidean distances between the connected atoms. In this representation, the task of the pattern extraction method may be formalized as: given a set of graphs defined as above, find all common and non-trivial sub-graphs which preserve shading and edge labels.

There isn't necessarily a polynomial time method for the maximal sub-graph search of two graphs. Therefore, the problem may become expensive in calculation time for graphs containing hundreds of vertices.

However, it will be appreciated that there will usually be many areas of commonality in local atomic configuration which arise purely coincidentally and are wholly unrelated to protein function. In the examples of FIGS. 1A and 1B, two such areas are designated 30 and 35 respectively. A large number of these areas may arise due to the limited number of amino acids and their tendency to form similar and repetitive structures even in the absence of specific functional significance. The difficulty of the problem arises in distinguishing the functionally significant area of common structure from the many randomly occurring areas of common structure in a computationally feasible manner.

In many embodiments of the invention, these problems are approached by first identifying a plurality of relatively small atom groups which appear in both protein molecules. Preferably, each relatively small atom group is defined as a set of atoms of similar atom type or chemical nature within a defined maximum distance from one another, and appearing in both protein molecules in a similar three-dimensional arrangement (typically by having similar distances between all corresponding atom pairs of the corresponding groups). As described above, however, many of these “common structural cliques” which appear in both proteins will be unrelated to protein function. To determine which regions of commonality are likely to be functionally significant, the set of common structural cliques may be searched to find overlapping common structural cliques, wherein two cliques “overlap” if they share at least one common atom. If two or more of the common cliques overlap in both protein molecules in a corresponding way such that a one to one mapping of atoms of all overlapping cliques can be made between the proteins, then the atoms which make up the overlapping set of cliques, as well as at least some of their relative distances from one another, is a candidate as a functionally significant structure, and is termed herein a “structural template” or “ST.” This principle is illustrated in FIGS. 2A and 2B using the atomic arrangements of FIGS. 1A and 1B. In this case, and as will be described later, a clique can be defined as a group of four atoms of corresponding atom type all within (for example) 8 angstroms of one another and in a similar three dimensional arrangement in both proteins. Groups 30 and 35 satisfy this test, but there is no second clique common to both proteins which overlaps these. This common structure of both proteins designated 30 and 35 is thus disregarded for further analysis as being unlikely to be functionally significant.

On the other hand, as illustrated in FIG. 2B. The five atom arrangements designated 20 and 25 are formed by three overlapping cliques of four atoms, wherein each four atom clique shares three atoms with each of the other two cliques. These three overlapping cliques thus define a five atom group that may, because it is formed by two or more overlapping cliques, be designated as a good candidate for functional significance and be saved or output as a structural template associated with the protein function.

This approach has several advantages. One is that common atomic arrangements between proteins formed by large groups of atoms that are relatively widely spatially separated can be identified without the computational expense of searching from scratch for large common arrangements in both proteins. The search for relatively small common cliques having a spatially limited extent is computationally reasonable, as is the process of searching for common overlaps between previously identified small cliques.

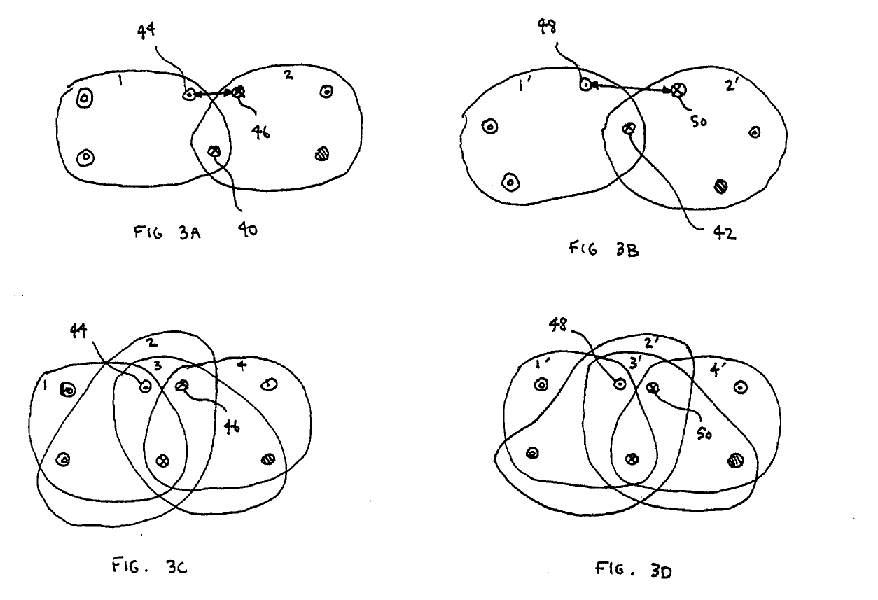

Another benefit is that this search for commonality allows for the detection and characterization of functionally significant common structures even if there is no direct three dimensional mapping that can be made between the two common structures. One example of this is illustrated in FIGS. 3A through 3D. FIG. 3A illustrates an example arrangement of eight atoms in one molecule, and FIG. 3B illustrates an example arrangement of eight atoms in a second molecule having the same function as the first. Common overlapping four atom cliques are present and labeled as cliques 1, 1′, 2 and 2′, where the two cliques share common atom 40 and 42 in the respective molecules. However, the orientation of the two cliques with respect to each other is not the same in both proteins, as they are rotationally oriented differently around common atom 40 and 42 respectively in the different molecules. Due to this differing orientation, the distance between corresponding atom pairs 44/46 and 48/50 are not the same in both proteins, and thus, these atom pairs do not belong to cliques which correspond between the two molecules. In some embodiments of the invention, the structural template that the algorithm creates only specifies atomic distances between atoms within cliques, but does not specify atomic distances that are between atoms that reside only in different ones of the overlapping cliques. Therefore, the structural template for an active site with a “hinge” as illustrated in FIGS. 3A and 3B will not specify the distance between the pair 44/46 and 48/50 because these two atoms only appear in separate cliques, but not a common clique. In this case, when the template is later applied to candidate molecules to detect the presence of the template defined atomic arrangement, a hit or match can be found in candidate molecules which have a variety of different distances between these atoms.

FIGS. 3C and 3D illustrate the same atomic arrangement, but wherein there is no orientation difference as appears in FIGS. 3A and 3B. In this case, the similarities in atomic position result in four overlapping common cliques, rather than two. In this situation, the distance between atoms 44/46 and 48/50 will be conserved in the structural template because now these atoms appear in corresponding cliques 2/2′ and 3/3′.

In advantageous embodiments, therefore, the structural template need not define the distances between every pair of atoms defined by the structural template. If the structural template comprises N atoms, there are generally N(N−1)/2 different and non-redundant atom pairs, and thus N(N−1)/2 different atom pair separation distances. In some embodiments of the invention, the structural template only defines a separation distance between two atoms if they are in at least one common clique of the set of overlapping cliques. Thus, fewer than the N(N−1)/2 separation distances are part of the template and are required to match a candidate protein molecule for determining or hypothesizing that the candidate molecule has the function indicated by a template match.

Embodiments of the present invention can be used in a variety of applications. For example, in some embodiments, the present invention can be used to create a library of function annotated structural templates. Further, the invention can be used to annotate a protein structure with a function based on its similarity to a previously defined template. A protein can be redesigned, enhanced, or otherwise modified to change or improve its function by altering it so as to more closely (or less closely) fit a pre-defined structural template associated with a particular molecular function. Novel proteins can also be designed that are predicted to have particular function as defined by a structural template.

In some particularly advantageous embodiments, a structural template can be used to refine a protein model structure. Previously, homology-based models were used for drug design in situations in which the structure of a protein of interest was not yet solved. In this method, structural information from known protein structures is extracted and used to predict possible structures of the unknown protein. Previous homology modeling methods typically focused on backbone similarities, without considering side chain configuration. However, in molecular modeling for drug design purposes, proper positioning of side chain atoms is often more important than characterizing the backbone. Side chain atoms typically define enzymatic active sites and binding sites. Further, side chain atoms of active sites and binding sites are often exposed to the outside environment; hence the most popular side chain conformation prediction methods, based on analysis of atom packing, are not applicable.

Some embodiments of the present invention overcome this problem by generating a structural template extracted from known structures of homologous proteins that can be used to refine structures around active sites and binding sites. In this method, a model of protein structure can be refined using techniques such as Molecular Dynamics and/or Monte Carlo methods to improve configuration of functionally relevant side chains.

Having two sets of extracted atom positions, a tree search method can be used to find cliques from both structures with similar distance matrices. This means that all atom pairs belonging to the clique should fulfill the distance-distance constraint. Searching for cliques can provide a tremendous increase in the efficiency of pruning the search tree, because of the option to define cliques restrictively.

In some cases, it can become unnecessary to use a graph isomorphism method to compare the structures because cliques are generally fully connected, complete graphs. Thus, the search results are a set of atom cliques from both structures with preserved atom identity and atom-atom distances for all atoms belonging to a clique. These cliques can now be used as a starting seed for iterative development of a template. Accordingly, each clique can be modified by adding additional vertices (atom pairs) or combining with other cliques in order to expand it to a larger common sub-graph of the two tested structures. In many cases, this sub-graph is non-complete (not all vertices will be adjacent); some atom pairs do not have any distance constraint. Thus, the presented approach can provide an important malleability feature to the active site description language, and can allow the user to capture similarities between active sites that are very difficult to compare otherwise, since they may not be directly superimposable.

Some embodiments of the present invention include extraction of structural templates for enzyme families and analysis of the performance of various algorithms using different values of geometrical parameters. In applying the structural template extraction algorithms, the Enzyme Classification (EC) number was used to define family membership for candidate protein structures (Bairoch 2000). This classification allowed us to objectively select protein structures for the structural template extraction procedure, and to define an objective criterion for evaluation of the extracted templates. We used the EC number assigned to structures by the authors of the source PDB file. This classification information was used here only in the stage of initial data set preparation, the definition of protein families. No other information extracted from the PDB file (for example active site definitions) was used in the structural template extraction procedure. Protein structures used in this work were taken from the representative set of non-redundant protein structures (Holm and Sander 1994). The sequence similarity threshold value was 25% to minimize trivial structural similarities resulting from sequence homology; the database version was from April 2002. In the case of multi-chain structures, all chains were included in CSC searches to include potential functional multimers and enzyme-inhibitor complexes.

In some advantageous embodiments, analysis of local similarities between protein structures using the CSC procedure occurs in four general steps. First, the compared protein structures are condensed to the atom graph representation, with atoms as nodes and atom-atom distances as edge labels. Second, local atom cliques are extracted from these atom graphs. Third, Common Structural Cliques are extracted by comparison of local atom cliques; preferably, all possible Common Structural Cliques are extracted. Fourth, the extracted CSCs are merged to create sets of larger and continuous graphs: structural templates that describe structural analogies between compared proteins.

To reduce the size of atom graphs representing protein structures, we selected representative atoms from protein side chains (Milik et al. 2002). Backbone atoms were excluded, because of the abundance of local structural cliques created by backbone atoms involved in secondary structure elements. These cliques in most cases are non-functional and can significantly increase input noise. The complete list of the selected atom types, with PDB codes, is presented in Table I. Other criteria can also be chosen as the representative set of atoms. For example, surface exposed atoms can be selected to compare structures of signaling proteins. Further, atoms from a binding site neighborhood can be chosen to analyze geometry of protein-ligand interactions, etc.

TABLE I
The complete list of the selected atom types, with their PDB codes.

| Amino | |
|---|---|
| acid | Atoms |
| Arg | NH1, NH2 |
| Asn | OD1, ND2 |
| Asp | OD1, OD2 |
| Cys | SG |
| Gln | OE1, NE2 |
| Glu | OE1, OE2 |
| His | ND1, NE2 |
| Lys | NZ |
| Met | SD |
| Pro | CG |
| Ser | OG |
| Thr | OG1 |
| Trp | NE1, CH2 |
| Tyr | CE1, CE2 |

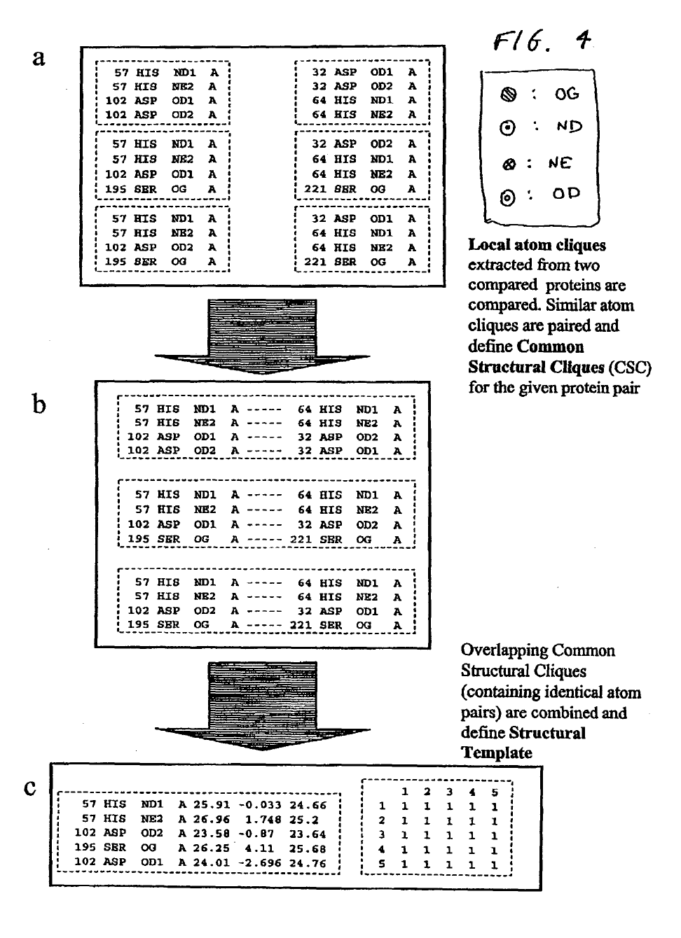

FIG. 4 illustrates some results of the application of the algorithm described above on a pair of functionally related proteins that produced results similar to those described conceptually above with reference to FIGS. 1 and 2. As described above and depicted in FIG. 4A, local atom cliques are sub-sets of atoms from protein structures with the property that every atom in the clique is closer than a threshold (8 Å in this example) from every other atom in the clique. 8 Å has been found to be a particularly suitable distance for this purpose, though some embodiments of the invention can use other criteria, and particularly other distances, for establishing cliques. In FIG. 4A, detected cliques for a first protein are shown on the left, and detected cliques for the second protein are shown on the right. In this case, Common Structural Cliques (CSC) are present, as shown in FIG. 4B (and illustrated conceptually in FIG. 2B), to establish correspondence between local atom cliques selected from the two protein structures in such a way that: respective inter-atomic distances between atoms belonging to the CSC are approximately equal in both protein structures and atoms belonging to the same pair have the same chemical identity. Further, in some embodiments, structural templates, shown in FIG. 4C, are created by overlapping CSCs (refer to FIG. 2B again for conceptual illustration). The structural template shown here contains a list of five atoms which make up the three overlapping cliques with their Cartesian coordinates in the first protein (on the left), and an adjacency matrix (on the right). The adjacency matrix defines which atom-atom distances are conserved in the template. A “1” in the matrix indicates that the column/row pair distance is part of the template. A zero indicates that the column/row atom pair distance is not part of the template and may vary when the template is applied to candidate molecules. In this particular examples, all distances are conserved. Review of FIG. 2B shows that in this example every atom is in at least one common clique with every other atom. Thus, all distances are conserved. As described above, however, this is not always the case, and some examples below include zeros in the adjacency matrix. In some specific embodiments, analysis of local similarities between protein structures using the CSC procedure occurs in the following series of general steps. First, the compared protein structures are condensed to the atom graph representation, with atoms as nodes and atom-atom distances as edge labels. Second, local atom cliques are extracted from these atom graphs, and local atom cliques (e.g. common structural cliques) common to both molecules are identified. Third, the extracted CSCs are merged to create sets of larger and continuous graphs which define at least one structural template that is advantageously associated with common molecular function.

The initial atom graph representation of a protein structure is here defined by a list of representative atoms, in conjunction with a matrix containing information about atom-atom proximity. This matrix (called the adjacency matrix in graph theory) contains value 1 in position (ij) when two atoms i and j are closer to each other than a pre-defined threshold distance, and value 0 when they are farther apart. Technically, such a defined adjacency matrix is an atomic-resolution version of the well-known “contact map” representation of protein structures. However, in this case, multiple points can be used for the definition of the local geometry of one residue. Distance threshold values 7, 8, and 9 Å were tested here. These threshold values were chosen based on analysis of the most prevalent local distances between atoms in typical enzymatic active sites. Tests of these threshold values showed that the result of the CSC template extraction procedure is not very sensitive to this parameter.

Preferably, the second stage of the procedure starts with extraction of all possible local atom cliques from the compared protein structural graphs. A local atom clique is defined here as a set of atoms from the structural graph with the property that every atom from this set is adjacent to every other atom from the same set. The adjacency is defined in the adjacency matrix created in the previous stage. In some embodiments, structural graphs are exhaustively searched to identify all four-node cliques. In other embodiments, common atoms in both molecules are first identified, which are grown to common pairs, common triplets, etc. if possible, to identify CSCs that may contain more or less than four atoms.

If atom cliques are first separately identified in the two molecules, all atom cliques from selected protein structure were pair-wise compared such that every local atom clique extracted from one of the protein structures was compared to each atom clique from the other protein graphs to find similarities and so define Common Structural Cliques.

A Common Structural Clique (CSC) establishes correspondence between two local atom cliques selected from two protein structures. Namely, inter-atomic distances between corresponding atoms belonging to the CSC are approximately equal in both protein structures, and corresponding atoms belonging to the same pair have the same chemical identity. Inter-atom distances were considered approximately equal when they differ less than 1 Å. This parameter was also tested with a value of 1.5 Å, on a set of protein structures from the serine protease family. The tests showed no evident improvement in the generated 3D pattern quality, but a drastic increase in the number of random—not related to active site—atom cliques.

Depending on the size of compared protein structures and their structural similarity, from one to more than 1000 CSCs can be extracted for a single protein pair. Because many extracted cliques share common atom pairs, they may be consolidated into larger constructs, called here structural templates. Often, structural templates created by overlapping CSCs contain conflicting cliques, where one atom from the first protein is paired in different cliques with several different atoms from the second protein. As a result, the proposed structural template should be pruned to remove inconsistencies, and the selected cliques should be merged in order to refine information about functionally relevant fragments of proteins. The CSC merging is preferably performed by a greedy algorithm, which attempts to generate a largest possible structural template that contains the atoms pairs most frequently used in the analyzed CSCs.

As mentioned above, the data format for the description of structural templates preferably contains a list of atoms, with their coordinates, that is extracted from one of the compared protein structures, and a square matrix, analogous to the adjacency matrix from graph theory. In some embodiments, this matrix is used to describe the expected importance of the distance between two atoms for the specific protein function. This importance can be evaluated by pair comparisons of protein structures from the given functional family. Preferably, it is defined as either “1”—meaning that the given distance is relevant, or “0”—meaning that it is irrelevant for the function. Application of this distance importance matrix can allow for formal description of flexible structural patterns, containing two or more rigid sub-patterns connected by flexible hinges. Such patterns are very difficult to describe in the rigid RMSD-based definition of structural patterns.

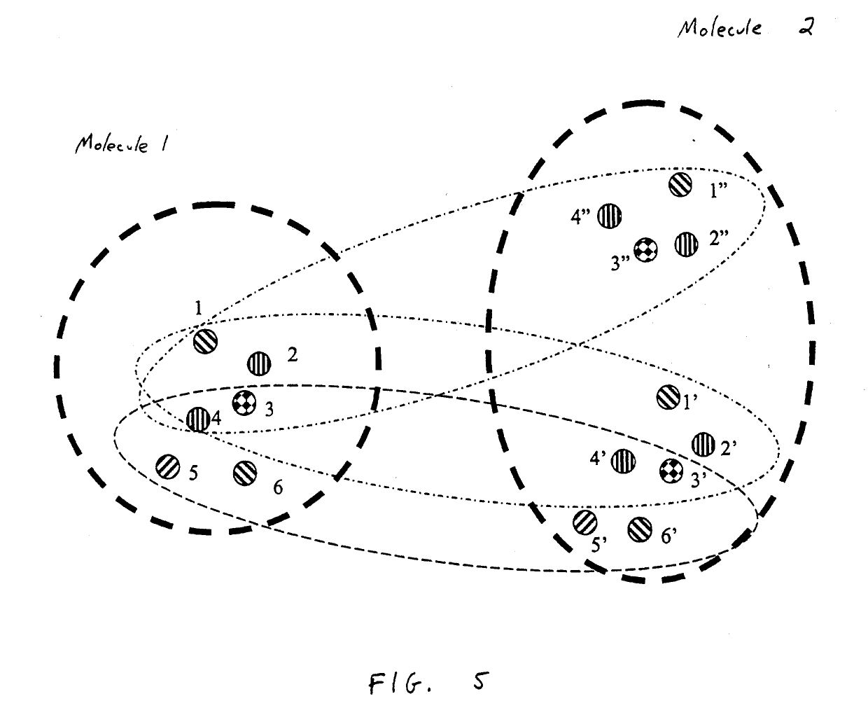

The merging algorithm preferably starts by selecting from the list the CSC containing the most overlaps (common atom pairs) with other CSCs. If multiple CSCs have the maximum number of overlaps, the algorithm preferably compares their number of conflicts and the CSC with the minimal number of conflicts can be chosen. The selected clique should then be used as a seed for the first draft of the structural template, which may be a superposition of all cliques that have overlaps with the previously chosen one. Usually, this structural template contains conflicts, which means that an atom from one protein is paired with multiple atoms from another. FIG. 5 shows an example of this.

Here, Molecules 1 and 2 contain several cliques which are compared and found to be CSCs. In Molecule 1, atoms 1, 2, 3, and 4 form a clique that maps to two different cliques in Molecule 2; one of these contains 1′, 2′, 3′, and 4′, while the other contains 1″, 2″, 3″, and 4″. Atoms 3, 4, 5, and 6 make up a clique that maps to the clique of atoms 3′, 4′, 5′, and 6′.

Because the clique containing atoms 1, 2, 3, and 4 from Molecule 1 is similar to two different 4-atom cliques in Molecule 2, our algorithm identifies these pairings as “conflicting pairs of cliques.” For example, atom 1 from Molecule 1 is simultaneously assigned to atoms 1′ and 1″ in Molecule 2. In order to remove this multiple assignment, either the clique containing atoms 1′, 2′, 3′, and 4′ or the clique containing atoms 1″, 2″, 3″, and 4″ must be removed from the list of cliques for Molecule 2. In this example, the clique containing 1′, 2′, 3′ and 4′ contains atoms that overlap with another clique in Molecule 2 that forms a CSC pair while the clique containing 1″, 2″, 3″, and 4″ does not. Therefore removal of the clique containing 1″, 2″, 3″, and 4″ is preferable, because the remaining cliques create a larger structural template, containing six atoms. This process may be referred to as “pruning.”

A proposed structural template should be pruned to eliminate conflicts and establish a one-to-one relation for atoms from compared proteins. In this process, conflicting cliques may be iteratively removed from the structural template definition. Every step of the pruning algorithm may select the CSC with the maximum number of conflicts with other CSCs in the overlapping set. If many cliques have the same number of conflicts, the one with the minimal number of overlaps may be chosen. The chosen CSC may then be removed from the structural template definition and CSC set; and the structural template may be rebuilt from the beginning with a new initial search for the CSC having the most overlaps with other CSCs and again tested for conflicts. This step can be repeated until the resulting structural template does not contain conflicting atom pairs.

In the first set of experiments we analyzed proteins structures from the serine endopeptidases family (EC numbers 3.4.21.-). This family contains hydrolases acting on peptide bonds. Table II contains the list of protein structures from the non-redundant database labeled with this EC number that also have resolution of 2.0 Å or better. Two important enzymes from this family are trypsin and subtilisin. The catalytic activity of trypsin is provided by a charge relay system involving an aspartic acid residue hydrogen-bonded to a histidine, which itself is hydrogen-bonded to a serine. The sequence fragments near the active-site serine and histidine residues are well conserved in this family (Brenner 1988). Catalytic activity of subtilase (Siezen et. al. 1991) is provided by a charge relay system similar to that in trypsin, however, it most probably evolved by independent convergent evolution (Brenner 1988). The sequences around the residues involved in the catalytic triad (aspartic acid, serine and histidine) are completely different from that of the analogous residues in the trypsin serine proteases.

TABLE II
The list of studied protein structures from the serine endopeptidase family
(EC 3.4.21.—).

| PDB | Res. | | |
|---|---|---|---|
| Code | [Å] | E.C. # | Compound |
| 1AVW | 1.75 | 3.4.21.4 | trypsin (Sus scrofa) |
| 1C5L | 1.47 | 3.4.21.5 | alpha thrombin (Homo Sapiens) |
| 1FLE | 1.90 | 3.4.21.36 | elastase (Sus scrofa) |
| 1FN8 | 0.81 | 3.4.21.4 | trypsin (Fusarium oxysporum) |
| 1GCI | 0.78 | 3.4.21.62 | subtilisin (Bacillus lentus) |
| 1SCJ | 2.00 | 3.4.21.62 | subtilisin e (Bacillus subtilis) |
| 1SGP | 1.40 | 3.4.21.81 | proteinase b (Streptomyces griseus) |

Two structures of aminotransferases, L-aspartate aminotransferase (1AJR, EC no. 2.6.1.1) and D-amino acid aminotransferase (1DAA, EC no. 2.6.1.21) were used in another application of the algorithm. Both enzymes catalyze the reaction where an α-amino acid is converted to an α-keto acid followed by conversion of a different α-keto acid to a new α-amino acid. Both proteins use the same cofactor, pyridoxal phosphate (PLP), in this process. The first aminotransferase converts L-aspartate to L-glutamate, and the second one catalyzes the analogous reaction, for D-forms of various amino acids in bacteria. The basic catalytic mechanism remains the same for both of them. However, amino acid sequences of these enzymes, as well as their structures, are very different and they were used as example of converging evolution of enzymes (Petsko and Ringe 2002).

The CSC algorithm, as presented above, depends primarily on two main geometric parameters: the distance threshold (used in the procedure of extracting local atom cliques from protein structures), and the distance tolerance parameter (used for definition of distance similarity in the CSC development procedure). Several combinations of these parameters were tested to locate values optimal for analysis of protein enzyme structures. The tests were performed on a set of low sequence homology (below 25%), high quality (2.0 Å or better resolution) structures of serine endopeptidases (EC 3.4.21.-). In this test, the seven selected structures were compared in pairs using the CSC algorithm with different values of parameters. Tested were combinations of geometric parameters for the local atom clique extraction procedure. Three values of distance threshold (7.0, 8.0 and 9.0 Å) and two values of distance tolerance (1.0 Å and 1.5 Å) were used.

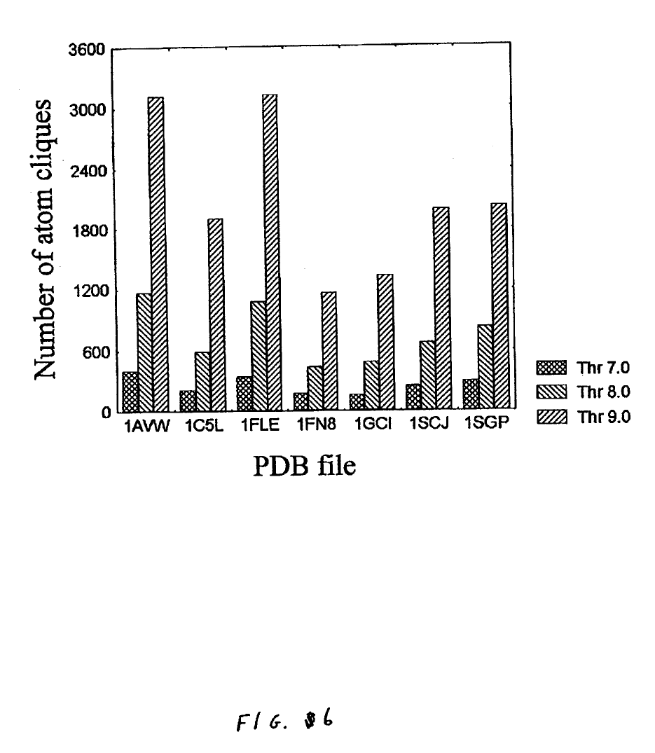

FIG. 6 shows the effect of maximum clique diameter definition on the number of four atom cliques identified in a selected protein. Here, the number of local atom cliques extracted from every structure in the serine endopeptidase set (EC 3.4.21.-) is shown for the three values of distance threshold (in angstroms). The number of local atom cliques, extracted from a single structure, grows approximately geometrically with the distance threshold increase. Analogously, numbers of extracted CSCs and sizes of final structural templates for all analyzed pairs of structures grow significantly with increasing values of the distance threshold parameter (Table IIIa) and the distance tolerance parameter (Table IIIb). Nevertheless, the size of the extracted structural templates does not depend strongly on the analyzed parameters, and the final structural templates for a given pair of structures overlap, in most cases. Therefore, distance threshold 8.0 Å and distance tolerance parameter 1.0 Å were used in the remaining part of this study.

Table III. CSC extraction results for the serine endopeptidase set (EC 3.4.21.-). The number of Common Structural Cliques for a given pair is presented below the diagonal, and the number of atoms in the final structural template derived from the given pair is presented above the diagonal.

In Table IIIa, the value of the distance tolerance parameter was constant at 1.0 Å, distance threshold values were selected as either 7 Å, 8 Å, or 9 Å.

In Table IIIb, The value of the distance tolerance parameter was 1.5 Å. The distance threshold was 8.0 Å

TABLE IIa

| | Thr | | | | | | | |
|---|---|---|---|---|---|---|---|---|
| | [Å] | 1AVW | 1C5L | 1FLE | 1FN8 | 1GCI | 1SCJ | 1SCP |
| 1AVW | 7 | | 9 | 9 | 10 | 6 | 6 | 8 |
| | 8 | | 11 | 10 | 10 | 5 | 7 | 9 |
| | 9 | | 11 | 13 | 16 | 10 | 8 | 10 |
| 1C5L | 7 | 39 | | 8 | 9 | 6 | 5 | 8 |
| | 8 | 105 | | 11 | 11 | 6 | 6 | 11 |
| | 9 | 295 | | 12 | 13 | 6 | 7 | 11 |
| 1FLE | 7 | 47 | 22 | | 8 | 7 | 6 | 9 |
| | 8 | 150 | 94 | | 10 | 7 | 5 | 10 |
| | 9 | 340 | 222 | | 10 | 8 | 9 | 13 |
| 1FN8 | 7 | 52 | 24 | 24 | | 6 | 5 | 8 |
| | 8 | 79 | 80 | 94 | | 5 | 6 | 11 |
| | 9 | 402 | 186 | 209 | | 5 | 9 | 14 |
| 1GCI | 7 | 20 | 11 | 13 | 5 | | 13 | 6 |
| | 8 | 31 | 19 | 19 | 12 | | 12 | 5 |
| | 9 | 77 | 25 | 45 | 26 | | 18 | 8 |
| 1SCJ | 7 | 30 | 13 | 13 | 4 | 25 | | 6 |
| | 8 | 45 | 20 | 29 | 8 | 124 | | 9 |
| | 9 | 89 | 62 | 69 | 23 | 338 | | 11 |
| 1SGP | 7 | 71 | 24 | 23 | 13 | 9 | 10 | |
| | 8 | 86 | 61 | 97 | 71 | 12 | 24 | |
| | 9 | 152 | 146 | 222 | 144 | 25 | 98 | |

TABLE IIIb

| | 1AVW | 1C5L | 1FLE | 1FN8 | 1GCI | 1SCJ | 1SGP |
|---|---|---|---|---|---|---|---|
| 1AVW | | 11 | 11 | 13 | 6 | 7 | 10 |
| 1C5L | 208 | | 11 | 11 | 6 | 6 | 11 |
| 1FLE | 410 | 167 | | 10 | 7 | 8 | 10 |
| 1FN8 | 300 | 106 | 183 | | 6 | 7 | 11 |
| 1GCI | 110 | 53 | 75 | 27 | | 13 | 7 |
| 1SCJ | 162 | 69 | 150 | 59 | 229 | | 11 |
| 1SGP | 235 | 152 | 251 | 168 | 45 | 111 | |

Serine Endopeptidases

Table IV presents lists of atoms included in structural templates definitions for the selected, representative structures of proteins that have the serine endopeptidase function. Rows of these tables correspond to atoms found in any structural template from the selected structure. Values of ‘1’ or ‘0’ describe whether the given atom is a member the corresponding structural template. For example, the first row of Table IVa contains information that the atom SG from residue 42 Cys, from chain A in the 1AVW structure was included in the structural templates created by comparison of this structure with 1C5L, 1FLE, 1FN8 and 1SGP. This atom was not included in STs created by comparison of this structure with the subtilisin structures 1GCI and 1SCJ. Table rows with information about atoms that belong to well-defined active site for serine endopeptidases (catalytic triad: His, Asp, Ser) are boldfaced. It is encouraging that in both presented examples almost all STs contained all the active atoms from the catalytic triad residue. The only exception is 1GCI/1SCJ pair, in which the oxygen from 125 Ser replaced the oxygen from 221 Ser, which is used in all remaining STs. Analogous results were obtained for remaining structure pairs from this family. The conclusion is that by using any of the pairs of structures as a source, one would be able to precisely locate the active site for the serine endopeptidase family in a fully automated procedure, from atom coordinates alone. Table IV. Atom conservation in diverse structural templates.

On the left side is a list of atoms from the 1AVW structure (Table Iva) or the 1GCI structure (Table Ivb) that appear in at least one derived structural template. Value “1” means that the atom was included in the structural template for the particular pair of structures, and value “0” means that it was not. Conserved atoms are in boldface.

TABLE IVa
The list of structural template atoms extracted from pairs trypsin (1AVW)
and remaining serine endopeptidase structures.

| | Atom | | 1c5l | 1fle | 1fn8 | 1gci | 1scj | 1sgp |
|---|---|---|---|---|---|---|---|---|
| | name | | 1avw | 1avw | 1avw | 1avw | 1avw | 1avw |
| 42 | Cys SG | A | 1 | 1 | 1 | 0 | 0 | 1 |
| 54 | Ser OG | A | 1 | 1 | 1 | 0 | 0 | 1 |
| 57 | His ND1 | A | 1 | 1 | 1 | 1 | 1 | 1 |
| 57 | His NE2 | A | 1 | 1 | 1 | 1 | 1 | 1 |
| 58 | Cys SG | A | 1 | 1 | 1 | 0 | 0 | 1 |
| 102 | Asp OD1 | A | 1 | 1 | 1 | 1 | 1 | 1 |
| 102 | Asp OD2 | A | 1 | 1 | 1 | 1 | 1 | 1 |
| 195 | Ser OG | A | 1 | 1 | 1 | 1 | 1 | 1 |
| 214 | Ser OG | A | 1 | 1 | 1 | 0 | 0 | 1 |
| 215 | Trp NE1 | A | 1 | 0 | 0 | 0 | 0 | 0 |
| 229 | Thr OG1 | A | 1 | 1 | 0 | 0 | 0 | 0 |
| 562 | Tyr CE1 | B | 0 | 0 | 0 | 0 | 1 | 0 |
| 562 | Tyr CE2 | B | 0 | 0 | 1 | 0 | 1 | 0 |

TABLE IVb
The list of structural template atoms extracted from pairs subtilisin (1CGI)
and remaining serine endopeptidase structures.

| | Atom | | 1avw | 1c51 | 1fle | 1fn8 | 1scj | 1sgp |
|---|---|---|---|---|---|---|---|---|
| | name | | 1gci | 1gci | 1gci | 1gci | 1gci | 1gci |
| 32 | Asp OD1 | A | 1 | 1 | 1 | 1 | 1 | 1 |
| 32 | Asp OD2 | A | 1 | 1 | 1 | 1 | 1 | 1 |
| 33 | Thr OG1 | A | 0 | 1 | 1 | 0 | 1 | 0 |
| 60 | Asp OD1 | A | 0 | 0 | 0 | 0 | 1 | 0 |
| 60 | Asp OD2 | A | 0 | 0 | 0 | 0 | 1 | 0 |
| 64 | His ND1 | A | 1 | 1 | 1 | 1 | 1 | 1 |
| 64 | His NE2 | A | 1 | 1 | 1 | 1 | 1 | 1 |
| 67 | His ND1 | A | 0 | 0 | 0 | 0 | 1 | 0 |
| 123 | Asn OD1 | A | 0 | 0 | 0 | 0 | 1 | 0 |
| 123 | Asn ND2 | A | 0 | 0 | 0 | 0 | 1 | 0 |
| 125 | Ser OG | A | 0 | 0 | 0 | 0 | 1 | 0 |
| 221 | Ser OG | A | 1 | 1 | 1 | 1 | 0 | 1 |
| 222 | Met SD | A | 0 | 0 | 1 | 0 | 1 | 0 |

Examples of two structural templates extracted for the serine endopeptidase family are presented in Tables Va and Vb. All tables containing structural template information are formatted as follows: the left side of the table contains pairs of atoms from both compared structures (for example 1AVW and 1GCI in the case of Table Va); and the right side of the table contains the adjacency matrix for the structural template for this particular pair of structures. For example, the first row of this table contains information that atom ND1 from residue 57His from chain A of structure 1AVW was included into the definition of the structural template for this structure, created by CSC comparison with the structure 1GCI. This atom was paired in a CSC with atom ND1 from residue 64His from chain A of structure 1GCI: additionally, all distances between this atom and all other atoms from the list are important for the structural template definition (the appropriate row in the adjacency matrix contains only 1's).

TABLE Va
Stuctural template extracted from structures of trypsin from Sus scrofa
(1AVW), and subtilisin from Bacillus lentus (1GCI), from the serine
endopeptidase family.
All tables containing structural template information are formatted as
follows: the left side of the table contains pairs of atoms from both
compared structures and the right side of the table contains the adjacency
matrix for the structural template for this particular pair of structures.

| | | | | | | | Adjacency | | | | |
|---|---|---|---|---|---|---|---|---|---|---|---|
| | 1AVW | | | 1GCI | | | matrix | | | | |
| | Atom name | | | Atom name | | | 1 | 2 | 3 | 4 | 5 |
| 1 | 57 | His | A | 64 | His ND1 | A | 1 | 1 | 1 | 1 | 1 |
| | | ND1 | | | | | | | | | |
| 2 | 57 | His | A | 64 | His NE2 | A | 1 | 1 | 1 | 1 | 1 |
| | | NE2 | | | | | | | | | |
| 3 | 102 | Asp | A | 32 | Asp OD1 | A | 1 | 1 | 1 | 1 | 1 |
| | | OD2 | | | | | | | | | |
| 4 | 195 | Ser OG | A | 221 | Ser OG | A | 1 | 1 | 1 | 1 | 1 |
| 5 | 102 | Asp | A | 32 | Asp OD2 | A | 1 | 1 | 1 | 1 | 1 |
| | | OD1 | | | | | | | | | |

TABLE Vb
Structural template extracted from structures of trypsin from Sus scrofa
(1AVW), and trypsin from Fusarium oxysporum (1FN8), from the serine
endopeptidase family.

| | 1AVW | | | 1FN8 | | | Adjacency matrix | | | | | | | | |
|---|---|---|---|---|---|---|---|---|---|---|---|---|---|---|---|
| | Atom name | | | Atom name | | | 1 | 2 | 3 | 4 | 5 | 6 | 7 | 8 | 9 |
| 1 | 57 | His ND1 | A | 57 | His ND1 | A | 1 | 1 | 1 | 1 | 1 | 1 | 1 | 1 | 1 |
| 2 | 57 | His NE2 | A | 57 | His NE2 | A | 1 | 1 | 1 | 1 | 1 | 1 | 1 | 1 | 1 |
| 3 | 58 | Cys SG | A | 58 | Cys SG | A | 1 | 1 | 1 | 1 | 1 | 1 | 1 | 1 | 0 |
| 4 | 195 | Ser OG | A | 195 | Ser OG | A | 1 | 1 | 1 | 1 | 1 | 1 | 1 | 1 | 1 |
| 5 | 42 | Cys SG | A | 42 | Cys SG | A | 1 | 1 | 1 | 1 | 1 | 1 | 0 | 0 | 0 |
| 6 | 54 | Ser OG | A | 54 | Ser OG | A | 1 | 1 | 1 | 1 | 1 | 1 | 1 | 0 | 0 |
| 7 | 102 | Asp OD1 | A | 102 | Asp OD1 | A | 1 | 1 | 1 | 1 | 0 | 1 | 1 | 1 | 1 |
| 8 | 102 | Asp OD2 | A | 102 | Asp OD2 | A | 1 | 1 | 1 | 1 | 0 | 0 | 1 | 1 | 1 |
| 9 | 214 | Ser OG | A | 214 | Ser OG | A | 1 | 1 | 0 | 1 | 0 | 0 | 1 | 1 | 1 |

The templates from Table Va and Table Vb were created by comparison of the same protein (porcine trypsin, 1AVW) with two different proteins. One of these proteins (bacterial subtilisin, 1 GCI) has different fold than trypsin and most probably evolved independently, as was discussed above. The second protein (fungal trypsin 1FN8) evolved from the same ancestor as the porcine trypsin and has similar fold. It may be seen that the second structural template is larger, which should be expected for homology reasons. It is significant that all the atoms from structure 1AVW that were included in the definition of the first structural template are also included in the second one. The relevant atom names are boldfaced in Table Vb for easier comparison. By comparing the non-homologous trypsin and subtilisin structures, we were able to identify an atom cluster that is known to be indispensable for performing the serine endopeptidase function.

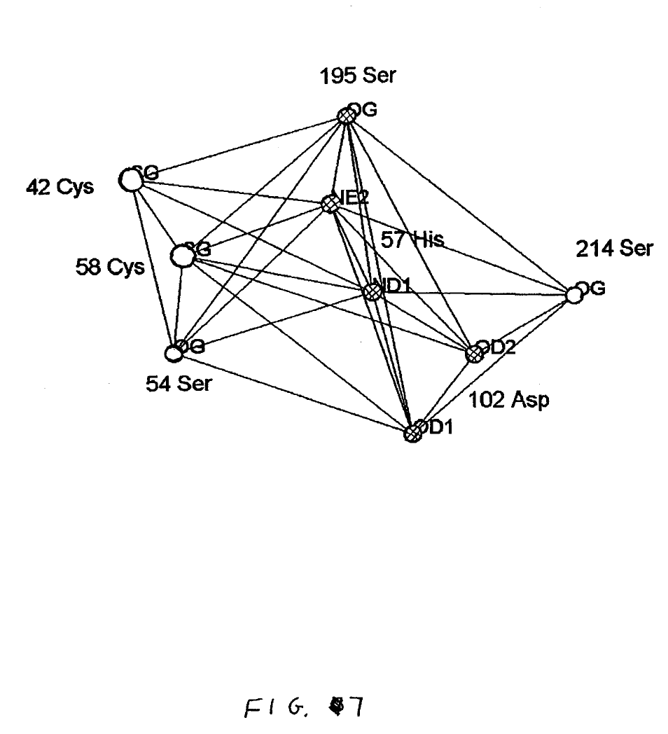

FIG. 7 shows the spatial arrangement of the atoms from 1AVW structure included in the structural template from Table Vb. Cross hatched circles represent atoms included in both structural templates from Table Va and Vb, open circles were only included in the structural template from Table Vb. Atoms are labeled by atom names and residue names from the PDB file definition. Lines connecting atoms represent atom-atom distances conserved in the structural template. The atoms from the catalytic triad (cross hatched) form the core of the structural template. These core atoms have neighbors on one side of two cysteines and a serine, and on the other side, of another serine. There are no conserved distances between these two groups of bordering atoms.

Aminotransferases

Aminotransferases: L-aspartate aminotransferase (1AJR), and D-amino acid aminotransferase (1DAA) are two completely different protein structures sharing a common biochemical function. They catalyze the same type of chemical reaction for substrates that have different chirality. These proteins form functional dimers, and the above described algorithm did not discover any structural templates when applied to single chains of these proteins. However, when we included all chains into the analysis process, the structural template presented in Table VI was extracted. The format of this table is analogous to the previously described Table V. The extracted structural template contained atoms from two tyrosines glutamic acid, and arginine residues. The connectivity matrix for the template is comparatively dense, which means that the distances between included atoms are similar in both structures. However, the adjacency matrix contains some zeros, meaning that distances between some atoms are excluded from the structural template definition. For example, the arginine atoms (numbers 7, 8) are coordinated only with atoms from one of the tyrosines from the complex (numbers 3, 4).

TABLE VI
Structural template extracted from the structures of the two aminotransferases, L-
aspartate aminotransferase (1AJR) and D-amino acid aminotransferase (1DAA). See FIGS.
5, 6, and Discussion for more details

| | 1AJR | | | 1DAA | | | Adjacency matrix | | | | | | | |
|---|---|---|---|---|---|---|---|---|---|---|---|---|---|---|
| | Atom name | | | Atom name | | | 1 | 2 | 3 | 4 | 5 | 6 | 7 | 8 |
| 1 | 263 | Tyr CE1 | A | 114 | Tyr CE1 | A | 1 | 1 | 1 | 1 | 1 | 1 | 0 | 0 |
| 2 | 69 | Glu CE1 | B | 20 | Glu CE2 | B | 1 | 1 | 1 | 1 | 1 | 1 | 0 | 0 |
| 3 | 70 | Tyr CE1 | B | 88 | Tyr CE2 | A | 1 | 1 | 1 | 1 | 1 | 0 | 1 | 1 |
| 4 | 70 | Tyr CE2 | B | 88 | Tyr CE1 | A | 1 | 1 | 1 | 1 | 1 | 0 | 1 | 1 |
| 5 | 263 | Tyr CE2 | A | 114 | Tyr CE2 | A | 1 | 1 | 1 | 1 | 1 | 1 | 0 | 0 |
| 6 | 69 | Glu OE2 | B | 20 | Glu OE1 | B | 1 | 1 | 0 | 0 | 1 | 1 | 0 | 0 |
| 7 | 266 | Arg NH1 | A | 98 | Arg NH2 | B | 0 | 0 | 1 | 1 | 0 | 0 | 1 | 1 |
| 8 | 266 | Arg NH2 | A | 98 | Arg NH1 | B | 0 | 0 | 1 | 1 | 0 | 0 | 1 | 1 |

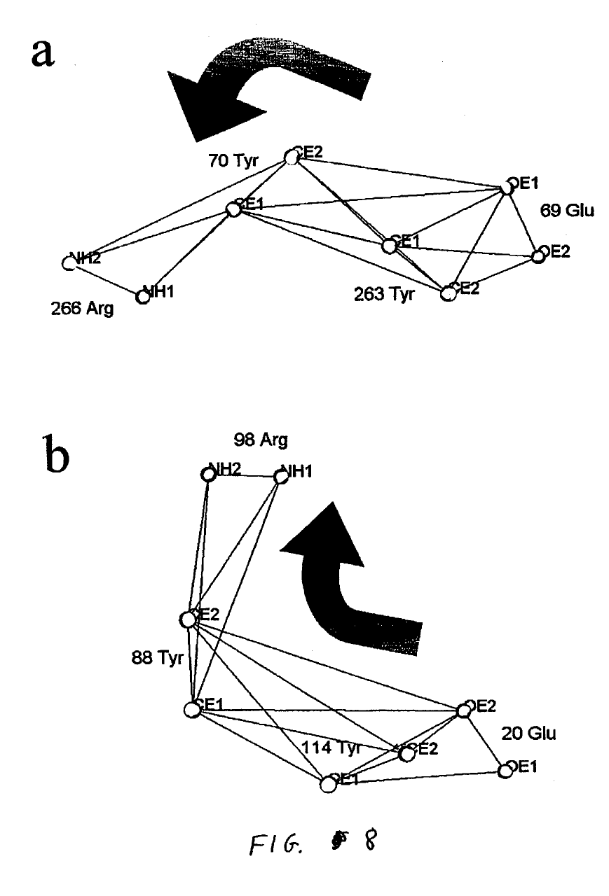

FIG. 8 shows a configuration of atoms from a structural template extracted from structures of L-aspartate aminotransferase (1AJR, EC 2.6.1.1) and D-amino acid aminotransferase (1DAA, EC 2.6.1.21). FIG. 8A shows structural template atoms from 1AJR, while FIG. 8B shows structural template atoms from 1DAA. Nitrogen atoms are labeled N, carbon atoms are labeled C, and oxygen atoms are labeled O. The core part of the structural template is formed by two interacting tyrosine residues. In 1AJR these residues belong to two different amino acid chains, in 1DAA they belong to the same chain. The glutamic acid side chain is correlated with core atoms on one of sides, and the arginine on the other side. According to the structural template definition, there is no distance correlation between glutamic acid and arginine side chains.

It is significant that while the template extraction procedure succeeded, it is impossible to overlay all atoms in these templates using a rigid body transformation. This results from the internal flexibility of our structural template definition. Some distances between structural template defining atoms were excluded from the structural template definition and the overall chirality of the pattern was disregarded. In this figure, only the atoms from tyrosines and glutamic acid were overlapped, leaving the arginine atoms unaligned. It may be seen that the structural template atoms from 1 AJR form a conformation that is almost a mirror image of atoms from 1DAA. This demonstrates how our algorithm's distance-based matching definition of a structural template is different from the most commonly used active site comparison that are based on rigid overlap (RMSD minimization). Notably, the basic difference in chemical functions of both compared proteins is chirality-based, that is, one of them converts L-amino acids and the second converts D-amino acids. Therefore, the template provides an example of how the chirality of the substrate possibly influences the chirality of the enzyme active site.

Presented results show that the proposed method for discovery of local similarities between protein structures works efficiently even in the case of large protein systems. For example, our algorithm was able to extract all local atom cliques from two dimeric aminotransferase structures containing 824 (1AJR) and 564 (1DAA) residues respectively, and then locate all possible matches between these atom cliques (CSCs). The calculations for aminotransferase structures, including the extraction of the final structural template from the CSC list, took less than 30 minutes on an 850 MHz PC. Additionally, this process can be fully automatic, allowing the analysis of local similarities for large sets of protein structures.

Methods described for joining overlapping CSCs and creating the final structural template work well in the majority of the tested cases; resulting sets of atoms are predominantly located in the neighborhood of the expected active site for the analyzed structures (see Table IVa, b, and Table Va, b). The clique-joining algorithm may be based on a greedy search method. It detected atoms from the catalytic triad in 20 out of 21 pairs of serine endopeptidase structures. In the failing case, the search was disrupted by a large clique of atoms from the inhibitor chain of the structure. However, the catalytic triad was localized for this pair of structures in the second run, after removing the inhibitor chain from the extraction process. In the case of aminotransferases, the algorithm extracted sets of atoms from the neighborhood of the cofactor molecule (see Table VI, and FIG. 8), which support the likely functional importance of these atoms. Although it can be difficult to prove that the cliques containing the most frequent atom pairs are always more functionally relevant; it is a plausible assumption in the case when the compared proteins have different structures and similar functions.

The results of the method parameters calibration tests (Table III a, b) show that the selected set of side chain atoms (see Table I) and proposed values of distance threshold (8.0 Å) and distance tolerance parameters (1.0 Å) work well for the tested structures. It will be appreciated, however, that other sensitivity parameters can be used for various applications of the present invention. As shown in FIG. 6, the number of initial local atom cliques that can be analyzed during the CSC creation procedure grows substantially as the distance threshold value increases. An increase in the number of local atom cliques generally implies an increase of CSCs for every analyzed pair of structures (see Table III a, below the diagonal). Nevertheless, the final structural templates remain basically the same, with only a slight increase in size (see Table III a, above the diagonal). Analogously, an increase in the value of distance tolerance (a parameter used in the atom clique comparison procedure) increases the number of initial CSCs (see Table III b, below diagonal) without drastic changes in the final structural templates (see Table III b, above the diagonal).

Analysis of the structural templates, even without looking at the structures or literature analysis, can provide some insight about the compared proteins. Taking the structural template extracted from the aminotransferase structures (Table VI) as an example, we can form a hypothesis: if the selected structural template contains functionally relevant residues from multiple chains and the chains are all from the same protein, then this protein form a functional multimer. The hypothesis is true for both analyzed enzymes. Additionally, in the case of 1AJR, the structural template is created by tyrosine and arginine from chain A, and tyrosine and glutamic acid from chain B; in the case of 1DAA both tyrosine residues are from chain A, and glutamic acid and arginine are from chain B. This suggests that this particular functional site is not sequence-dependent and most probably evolved as an effect of a convergence process.

Some embodiments of the present invention include applying an algorithm to extract common structural features from proteins that catalyze a particular chemical reaction, but evolved from different ancestors due to convergent evolution. Such a technique for pattern extraction has various advantages over sequence-homology-based methods which can focus on similarities in the evolutionary origin of proteins rather than similarities in their present function. Additionally, methods of the present invention can encompass a useful malleability feature of the active site description. Some methods of the present invention can allow an expression of similarities between active sites that are very difficult to describe otherwise, in some cases because they cannot be superimposed by a rigid body transformation.

The template extraction algorithm generally works best for comparison of non-significantly similar structures of proteins expressing some common feature or function. When the configuration of the template atoms is conserved in either convergent or divergent protein structures sharing the same function, then the selected set is likely to contain functionally relevant atoms.

The algorithm described in detail above for extracting structural templates involved identifying four node cliques in separate proteins, identifying common four node cliques, and then identifying commonly overlapping sets of common four node cliques. Other methods of identifying overlapping cliques (not necessarily of four nodes each) can also be used to define a structural template.

In one such alternative embodiment, a clique common to two molecules P₁ and P₂ is defined as follows:

1. atoms a₁ⁱ is extracted from structural graph P₁ and atoms a₂ⁱ from P₂

2. atoms belonging to the same pair: a₁ⁱ and a₂^{j} have the same chemical identity

3. distances between atoms in clique are compatible; i.e. for every two atoms from graph P₁ and their complementary atoms from graph P₂, the difference in the distances is less than a given threshold (1 Å)

4. distance between any pair of atoms in a clique is less than a threshold value (8 Å)

5. clique atoms from structure corresponding to graph P₁ and clique atoms from structure corresponding to graph P₂ form configurations with the same chirality, i.e. for every pair of 4 corresponding atoms both quadruplets have the same chirality.

In this embodiment, atom clique establishes correspondence between two compact (Rule 4) subsets of atoms, selected from two protein structures (Rule 1), in the way that inter-atom distances (Rule 3) and overall chirality (Rule 5) are conserved. In this embodiment, however, the number of atoms is not part of the clique definition. Rules 3, 4, 5 are quite effective at pruning search tree, leading to manageable computing time, e.g. for two medium size proteins (300 residues) clique search process takes time in range from couple of minutes to half hour. This time depends mostly on overall structural similarity of the compared proteins. Using this definition of primitive atom clique, we are able to compare two protein structures and extract common and overlapping atom cliques using the algorithm below:

Start from two protein structures (P₁ and P₂) sharing a common, structure-related feature (for example: active site, binding site, metal coordination site, etc.)

For every pair of atoms from structure P₁ search for all analogous pairs of atoms from structure P₂ that conform to the atom clique definition,

continue extending the new clique by adding new atom pairs to it, always checking atom clique definition, until no new extension is possible.

If the final clique candidate contains four or more atom pairs—add it to the list of extracted cliques

Extracted cliques are checked for isomorphism with already extracted cliques and the bigger clique is retained

Atom cliques containing less than 5 nodes that do not share any atom pairs with any other cliques are excluded from the list.

The above procedure may be summarized as a greedy, deep-first tree traversing procedure and is used to search exhaustively sets of atoms extracted from protein structures containing up to one thousand atoms each.

After this search, a merging function is also performed to identify commonly overlapping common cliques. As set forth above in conjunction with the first algorithm, we are interested in one-to-one mapping between atoms of both compared structures. Thus, conflicting cliques are therefore removed from our list to create such mapping. It may be done in an iterative way, where one of the conflicting is removed from the list and the cliques are de novo joined into graphs. The clique to be removed is chosen in the way that remaining cliques have maximal possible coverage in assigning atoms from structure P₁ to atoms from structure P₂. This procedure is repeated until maximal one-to-one mapping between chosen atoms from structures P₁ and P₂ is obtained.

Sometimes such a procedure may create two or more mutually exclusive versions of graphs of comparative cardinality. It may be an indication that at least one of compared structures contains multiple active sites of similar structural features. In this case, multiple versions of the graphs may be kept for further analysis.

Regardless of the algorithm used, however, the goal is to find overlapping common cliques that overlap in a common consistent way in both compared structures. When such a structure is found, it is a candidate for being a functionally associated structural template.

A variety of other modifications to the specific algorithms and techniques above may be made. One area in which this is true is in the molecular representation used. Most of the interesting protein structures contain thousands of atoms making protein structure comparison very expensive. The approach described above is to select a subset of atoms that will still preserve most of the information relevant for the protein function. The nature of this selection depends on the specific biological function of the chosen protein family. For example, one may select polar atoms from amino acid side chains, when one is interested in catalytic function and/or ion binding sites. Surface exposed atoms are appropriate for signal proteins, receptors and membrane proteins, while atoms involved in protein-protein interfaces may be chosen for protein complexes. Entity selection does not have to be restricted to atoms and may for example consists of groups of atoms or whole residues or abstract geometrical entities, like descriptors of electrostatic field around the protein. We present an example application above to templates extracted from positions of polar atoms from side chains of globular protein structures. This feature selection appears to be favorable to extraction of structural templates related to catalytic function of enzymes.

It will be appreciated that some embodiments of the present invention can utilize a computer, particularly a general purpose computer that is programmed to perform one or more of the steps described herein. Such a computer will advantageously include computer readable media, a user input, a processor, and a display.

Furthermore, it will be appreciated that although techniques are described herein with particular applicability to protein molecules, some embodiments of the invention have application to other molecules as well, such as smaller organic and drug candidate molecules.

References:

The following references include information on methods of characterizing protein structure and function. All references herein are expressly incorporated by reference in their entirety.

Artymiuk, P. J., Poirrette, A. R., Grindley, H. M., Rice, D. W. and Willett, P. (1994) J. Mol. Biol., 243, 327-344.

Axe, D. D., Foster, N. W., Fersht, A. R. (1996) Proc. Natl. Acad. Sci. USA, 93, 5590-4.

Bairoch, A., (2000) Nucleic Acids Res. 28,:304-305.

Berman, H. M., Westbrook, J., Feng, Z., Gilliland, G., Bhat, T. N., Weissig, H., Shindyalov, I. N.,

Bourne, P. E. (2000) Nucleic Acids Res., 28, 235-242.

Brenner S., (1988) Nature, 334, 528-530.

Chothia, C. and Lesk, A. M. (1986) EMBO J., 5, 823-6.

Chotia, C. and Gerstein, M. (1997) Nature, 385, 579-581.

Di Gennaro, J. A., Siew, N., Hoffman, B. T., Zhang, L., Skolnick, J., Neilson, L. I. and Fetrow, J. S. (2001) J. Struct. Biol., 134, 232-245.

Fetrow, J. S. and Skolnick, J. (1998) J. Mol. Biol. 281, 949-968.

Fisher, D., Wolfson, H., Lin, S. L. and Nussinov, R. (1995) Prot. Sci., 3, 769-778.

Fisher, D., Tsai, C. J., Nussinov, R. and Wolffson, H. (1995) Protein Eng. 8, 981-997.

Gassner, N. C., Baase, W. A. and Matthews, B. W. (1996) Proc. Natl. Acad. Sci. USA, 93, 12155-8.

Hobohm, U. and Sander, C. (1994) Protein Sci., 3, 522

Irving, J. A., Whisstock, J. C. and Lesk, A. M. (2001) Proteins, 42, 378-382.

Ko, E. P., Akatsuka, H., Moriyama, H., Shimnyo, A., Hata, Y., Katsube, Y., Urabe, I. and Okada H. (1992) Biochem. J. 288, 117-121.

Lesk, A. M. and Chothia, C., (1980) J. Mol. Biol., 136, 225-70.

Milik, M., Szalma, S. and Olszewski, K. A. (2002) In Guigo, R. and Gusfield, D. (ed.), “Algorithms in Bioinformatics”, Springer.

Petsko, G. and Ringe, D. (2002) “Protein Structure and Function: From Sequence to Consequence” New Science Press. (e-book: http://www.new-science-press.com/browse/protein/)

Reddy, B. V., Li, W. W., Shindyalov, I. N. and Bourne, P. E. (2001) Proteins, 42, 148-63.

Reva, B., Finkelstein, A. and Topiol, S. (2002), Proteins, 47, 180-193.

Russel, R. B. (1998) J. Mol. Biol. 279, 1211-1227.

Russell, R. B., Sasieni, P. D. and Sternberg, M. J. (1998) J. Mol. Biol., 282, 903-18

Siezen, R. J., de Vos, W. M., Leunissen, J. A. M. and Dijkstra, B. W. (1991) Protein Eng. 4, 719-737.

Tull, D., Withers, S. G., Gilkes, N. R., Kilburn, D. G., Warren, R. A. J. and Aebersold R. (1991) J. Biol. Chem. 266, 15621-15625.

Turcotte, M., Muggleton, S. H. and Stemberg, J. E. (2001) J. Mol. Biol., 306, 591-605.

Wallace, A. C., Laskowski, R. A. and Thomton, J. M. (1996) Protein Sci., 5, 1001-13.

Wallace, A. C., Borkakoti, N. and Thornton, J. M. (1997) Protein Sci., 6, 2308-23.

What is claimed is:

1. A method of analyzing a selected molecule under study comprising:
extracting a set of feature cliques which are common to both a first molecule and a second molecule such that each feature clique extracted from said first molecule maps to at least one corresponding extracted feature clique with similar characteristics in the second molecule;
identifying a set of at least two feature cliques in said first molecule which overlap, wherein the feature cliques of the second molecule which correspond to the at least two overlapping feature cliques of the first molecule also exhibit a corresponding overlap;
defining a structural template comprising the set of features of said first molecule included in said overlapping cliques; and
comparing said structural template to feature positions in said selected molecule under study.

2. The method of claim 1, further comprising:
performing said extracting, identifying, and defining steps on said first molecule and a third molecule so as to produce a second structural template;
refining either the first or second structural template by comparing said first and second structural templates; and
using said refined structural template for said comparing step.

3. The method of claim 1, further comprising characterizing the activity of the molecule under study as similar or dissimilar to said first and second molecules.

4. The method of claim 1 wherein each feature clique comprises a group of atoms of selected types.

5. The method of claim 4, wherein each feature clique comprises a spatial arrangement of four or more atoms.

6. The method of claim 5, wherein corresponding atom cliques have similar characteristics if corresponding clique atoms are of the same type and corresponding relative distances between clique atoms differ by less than a threshold value.

7. The method of claim 1 wherein the molecules are proteins.

8. The method of claim 1 wherein the molecules are organic molecules.

9. The method of claim 1, wherein said structural template further comprises a set of conserved distances between different features of said structural template.

10. The method of claim 9, wherein said set of conserved distances is less than the total set of distances between all of said different features.

11. The method of claim 10, wherein a distance between two features is a member of the conserved set if the respective features are members of a common clique, and wherein a distance between two features is not a member of the conserved set if the respective features are not members of any common clique.

12. A method of defining a structural template indicative of molecular function comprising:
defining a set of N features; and
defining a set of relative distances between said N features, wherein said set defines at least one relative distance between each one of said N features to at least one other of said N features, and wherein said set defines less than the N(N−1)/2 possible relative distances between all of said N features.

13. A method of identifying a functionally significant atom group comprising a portion of a larger molecule, said method comprising:
identifying a plurality of relatively small atom groups which appear in both a first molecule and a second molecule; and
identifying at least one larger atom group formed by a plurality of overlapping ones of said small atom groups, the larger atom group being defined by identifying a corresponding overlap of corresponding small atom groups in both of said molecules.

14. A method of locating a functionally significant molecular portion comprising:
extracting a set of feature cliques which are common to both a first molecule and a second molecule such that each feature clique identified in said first molecule maps to at least one corresponding feature clique in the second molecule having similar characteristics;
identifying a set of at least two feature cliques in said first molecule which overlap, wherein the feature cliques of the second molecule which correspond to the overlapping feature cliques of the first molecule also exhibit a corresponding overlap;
defining a structural template comprising the set of features of said first molecule included in said overlapping cliques; and
identifying the location on said molecule where said features of said structural template are located.

15. A method of defining a functionally significant structural molecular feature comprising:
defining a set of features, each feature having one or more selected physical characteristics; and
defining a set of distances between some of said features but not all of said features.

16. The method of claim 15, wherein said features comprise atoms of selected physical characteristics.

17. A method of defining a structural template of molecular features comprising:
defining a set of features and a set of conserved distances between the features, wherein said features are defined by:
extracting a set of feature cliques which are common to both a first molecule and a second molecule such that each feature clique identified in said first molecule maps to at least one corresponding feature clique in the second molecule having similar characteristics;
identifying a set of at least two feature cliques in said first molecule which overlap, wherein the feature cliques of the second molecule which correspond to the overlapping feature cliques of the first molecule also exhibit a corresponding overlap; and
defining said features of said structural template as the set of features of said first molecule included in said overlapping cliques;
wherein said set of conserved distances is defined to include only those distances between a selected pair of features when both features of the selected pair are members of a common feature clique.

18. A computer readable media having stored thereon computer code operative to perform a method of analyzing a selected molecule under study, the method comprising the steps of:
extracting a set of feature cliques which are common to both a first molecule and a second molecule such that each feature clique extracted from said first molecule maps to at least one corresponding extracted feature clique with similar characteristics in the second molecule;
identifying a set of at least two feature cliques in said first molecule which overlap, wherein the feature cliques of the second molecule which correspond to the at least two overlapping feature cliques of the first molecule also exhibit a corresponding overlap;
defining a structural template comprising the set of features of said first molecule included in said overlapping cliques; and
comparing said structural template to feature positions in said selected molecule under study.

19. The computer readable media of claim 18, wherein the method further comprises:
performing said extracting, identifying, and defining steps on said first molecule and a third molecule so as to produce a second structural template;
refining either the first or second structural template by comparing said first and second structural templates; and
using said refined structural template for said comparing step.

20. A computer readable media having stored thereon computer code operative to perform a method of defining a structural template indicative of molecular function, the method comprising the steps of:
defining a set of N features; and
defining a set of relative distances between said N features, wherein said set defines at least one relative distance between each one of said N features to at least one other of said N features, and wherein said set defines less than the N(N−1)/2 possible relative distances between all of said N features.

21. A computer readable media having stored thereon computer code operative to perform a method of defining a structural template of molecular features comprising, the method comprising the steps of:
defining a set of features and a set of conserved distances between the features, wherein said features are defined by:
extracting a set of feature cliques which are common to both a first molecule and a second molecule such that each feature clique identified in said first molecule maps to at least one corresponding feature clique in the second molecule having similar characteristics;
identifying a set of at least two feature cliques in said first molecule which overlap, wherein the feature cliques of the second molecule which correspond to the overlapping feature cliques of the first molecule also exhibit a corresponding overlap; and
defining said features of said structural template as the set of features of said first molecule included in said overlapping cliques;
wherein said set of conserved distances is defined to include only those distances between a selected pair of features when both features of the selected pair are members of a common feature clique.
